(19) United States
(12) Patent Application Publication
(10) Pub. No.: US 2007/0068880 A1
(43) Pub. Date: Mar. 29, 2007

(54) Portable purifier for potable liquids

(76) Inventors: Harusuke Naito, Oneonta, NY (US); David E. Fowler, Gainesville, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/605,623

(22) Filed: Nov. 28, 2006

Related U.S. Application Data
(63) Continuation of application No. 10/865,209, filed on Jun. 10, 2004.

(51) Int. Cl. C02F 1/00

(52) U.S. Cl. 210/767

(57) ABSTRACT

The subject invention pertains to devices and methods for treating potable liquids. In particular, the subject invention concerns portable devices for use in the removal of contaminants, i.e. chlorine, chloramines, metals, undesirable flavors or odors, from potable liquids. According to the subject invention, portable devices for use in treating potable liquids include a media retaining means, a manipulating means, and purifying media.

### CROSS-REFERENCE TO RELATED APPLICATIONS

This application is a continuation application of co-pending patent application U.S. Ser. No. 10/865,209, filed Jun. 10, 2004, which is hereby incorporated by reference in it's entirety.

### FIELD OF THE INVENTION

The present invention relates to devices and methods for purifying and improving the flavor of potable liquids. More particularly, the present invention relates to portable devices that efficiently remove chlorine, chloramines, and other residual contaminants as well as improve the flavor of potable liquids.

### BACKGROUND OF THE INVENTION

There are numerous chemicals in tap water due to treatments used in reducing and/or killing harmful agents, such as bacteria and viruses, in water systems. Chlorination (i.e., addition of hypochlorous acid) (including the use of chloramine) is a common method currently used in purifying water for drinking. While certain properties of hypochlorous acid are effective in killing bacteria, hypochlorous acid itself may be deleterious to the equipment or treatment systems being used. In addition excess chlorine in drinking water often imparts an undesirable taste and odor to the water and the effluent water can be harmful to the environment. Further, recent studies suggest that chlorine and chloramine are harmful and toxic chemicals (see Craun, GF, “Epidemiologic studies of organic micropollutants in drinking water,” Sci. Total Environ. 47,461-472 (1985); Daniel, FB etal., “Comparative 90-day subchronic toxicity studies of three disinfectants,” J. Amer. Water Works Assoc. 82, 61-69(1990)).

Although such treatment methods (i.e., chlorine and/or chloramine addition) are necessary to make water microbiologically safe, there is a growing concern that they may actually be detrimental to health. Several studies have shown that exposure to chlorine/chloramine as well as chlorination by-products (CBP), such as trihalomethanes (THM), may promote carcinogenic response in mammals. For example, certain studies have suggested an association between THM exposure and the incidence of specific cancers (i. e., pancreatic cancer and colon cancer). See King et al., “Case-Control Study of Colon and Rectal Cancers and Chlorination By-Products in Treated Water,” Cancer Epidem., 9:813-818 (2000) and Carlo, Gi and C. J. Mettlin, “Cancer incidence and trihalomethane concentration in a public drinking water system,” Am. J. Pub. Health, 70(5):523-4 (1980).

In the field of fluid treatment, and particularly in the field of treating water for commercial, industrial and domestic use, a number of systems have been proposed, some or all of which have certain undesirable characteristics, drawbacks or disadvantages associated therewith.

For example, ion-exchange systems are commonly used to soften water and selectively remove specific impurities from the water to improve flavor. The active medium of an ion-exchanger is an ion-exchange resin which is designed to remove undesirable constituents from the fluid and replace those undesirable constituents with a less undesirable constituent. Unfortunately, such ion-exchange systems are large and bulky. Further, the bed of resin eventually becomes exhausted and the unit must be removed from service and be regenerated to become useful again. In addition to the drawback of chemical exhaustion, bacteria often fill an ion-exchange resin tank to plug up chemical feed nozzles and other orifices. The resin is also susceptible to chemical degradation (i.e., chlorine present from a bacteria treatment process can degrade the resin). The ion-exchanger unit, which is bulky and must be carefully maintained and monitored to assure continued acceptable performance, does not provide an effective portable means for purifying water.

Another popular process for treating water utilizes the concept of reverse osmosis. With reverse osmosis, pressure in excess of the osmotic pressure of the fluid is used to force untreated water, normally at ambient temperature, through a selective membrane in a direction opposite to that normally observed in osmotic processes. The selective membrane is designed to allow the water to permeate through while rejecting the dissolved undesirable constituents. The success of this process depends in large part upon the development of suitable membranes. Membranes utilized in reverse osmosis typically experience a variety of temperature, chemical and pressure stability problems as well as speed and capacity limitations. Moreover, bacteria can produce a fouling film on reverse osmosis membranes. If the water supply is treated with chlorine as an antibacterial agent to prevent bacterial film formation, the dissolved chlorine often has a deleterious effect on reverse osmosis membranes. Additionally, reverse osmotic equipment are expensive, complicated to use, and must be carefully set up, maintained, and monitored. Accordingly, reverse osmotic equipment would not provide an effective, portable means for purifying liquids.

Moreover, commercially available devices and methods for the removal of chlorine and other objectionable tastes/odors from tap water often require connection with a water line and employ activated granular carbon through which water from the water line flows before exiting out of a faucet. Aside from the effort and expense of installing devices of this sort, there is a much more serious objection to the sole use of granular activated carbon. Unfortunately, activated granular carbon is an excellent breeding ground for the growth of bacterial and certain other organic substances. As a result, after a short period of use, water exiting from a filtering device that utilizes activated granular carbon often contains bacteria and other organic matter.

Accordingly, there is a need for a portable, simple, and inexpensive device that can consistently purify and treat liquids in the removal of contaminants.

### BRIEF SUMMARY OF THE INVENTION

As noted above, potable liquids often contain undesirable constituents, requiring treatment of the liquid prior to consumption. This invention finds advantageous utility in the treatment of potable liquids to improve the taste or flavor of the liquids. In particular, the present invention removes from potable liquids, in particular water, undesirable constituents contained therein such as, for example, dissolved chlorine and chloramine.

As noted above, chlorine and chloramine, which are necessary in drinking water for disinfection (as mandated by departments of public health across the nation), represent health and esthetic risks to the consumer. The subject invention offers devices and methods for the effective removal of undesirable constituents from potable liquids. In a preferred embodiment, the present invention offers portability, convenience and efficiency in removing chloramine or chlorine from potable liquids to purify and improve taste.

In accordance with the subject invention, a portable device for purifying and improving the flavor of potable liquids comprises: a purifying media, wherein the purifying media is composed of either calcium sulfite, activated carbon, high-purity copper-zinc formulations (commonly referred to as KDF), far infrared ceramics, or any combination thereof; a water-permeable means for retaining purifying media; and a means for manipulating the media retaining means so as to allow the desired potable liquid to pass through the purifying media in the media retaining means.

The subject portable device and method can treat or improve the taste of most potable liquids including, for example, tap water, alcoholic beverages (i.e., wines, liqueurs), carbonated beverages (i.e., sodas), fruit-based beverages (i.e., juices), cold beverages (i.e., milk), hot beverages (i.e., teas, coffees), etc.

In certain embodiment of the invention, the device is reusable. In other embodiments, the subject device is disposable.

In one embodiment, the media retaining means is a container composed of a water-permeable material that enables any potable liquid to easily flow therethrough while retaining the purifying media therein. Alternatively, the media retaining means is a non-toxic adhesive that is used to securely attach the purifying media to a surface, i.e. of the manipulating means.

According to the subject invention, the media retaining means is attached to the manipulating means. The manipulating means is a structure that is easily grasped and maneuvered so as to encourage the flow of a desired potable liquid through the purifying media in the media retaining means.

In a method of use, the media retaining means of the subject invention is immersed into a potable liquid; the manipulating means is handled in order put the media retaining means into motion within the potable liquid so that the potable liquid comes into contact with the purifying media within the media retaining means; then, the manipulating means, and corresponding media retaining means, are removed from the now treated potable liquid to allow for consumption of the potable liquid.

An advantage of the present invention is its ability to reduce the concentration of undesirable chemicals, flavors, and/or odors present in potable liquids. This is of particular value in the treatment of drinking water. It is highly desirable to have available a portable, simple treatment device that will eliminate or reduce the concentration of many undesirable contaminants to improve the taste of the potable liquid.

### BRIEF DESCRIPTION OF THE DRAWINGS

FIG. 1 shows a side view of one embodiment of the invention, wherein the media retaining means is a water-permeable container.

FIG. 2 shows a side view of another embodiment of the invention, wherein the media retaining means is a non-toxic adhesive.

### DETAILED DISCLOSURE OF THE INVENTION

The present invention concerns portable devices and methods for treating potable liquids. The portable devices of the subject invention include a media retaining means, a manipulating means, and purifying media. Specifically, the media retaining means retains the purifying media and is attached to the manipulating means. In use, the media retaining means of the invention is immersed in a desired, potable liquid; the manipulating means is handled in order put the media retaining means into motion within the potable liquid so that the potable liquid comes into contact with the purifying media within the media retaining means; then, the manipulating means, and corresponding media retaining means, are removed from the now treated potable liquid to allow for consumption of the potable liquid.

According to the present invention, the purifying media is composed of any materials known to the skilled artisan to be effective in treating liquids (i.e., drinking water). As contemplated herein, purifying media includes, but is not limited to, far infrared emitting ceramics, calcium sulfite, activated granular carbon, metal particulate matter (such as those disclosed in U.S. Pat. Nos. 6,197, 204; 5,951,869; 5,833,859; 5,599,454; 5,510,034; 5,433,856; 5,415,770; 5,314,623; 5,275,737; 5,269,932; 5,198,118; 5,135,654; 5,122,274; 4,642,192), resins (such as those disclosed in U.S. Pat. No. 4,455,236), and finely broken pieces of natural materials (i.e., quartz porphyry, taicho stone, and bukahan stone). Preferably, the purifying media is of a size and shape that can be easily retained by the media retaining means while also permitting potable liquid access to the purifying media.

In a preferred embodiment, the purifying media includes activated granular carbon, calcium sulfite, far infrared ceramics, metal particulate matter (i.e., KDF Fluid Treatment, Inc., Three Rivers, MI), natural materials (i.e., quartz porphyry, taicho stone, and bukahan stone), or any combination thereof.

Granular activated carbon, as described above, is an effective material in removing chlorine and chloramines from water. Far infrared ceramic is used, according to the invention, to enhance specific qualities of water (i. e., wetness) as well as enhance the taste of potable liquids (i. e., effect smoother tasting wines, more aged; enhance the flavors in sodas, teas, and coffees), whereas calcium sulfite and metal particulate matter, such as KDF, efficiently remove chlorine and chloramines from the liquid. Most metal particulate matter can provide a dual function in the subject invention. For example, they can remove certain chemical constituents (i.e., chorine and chloramines) as well as serve as a deterrent against microorganism colonization.

In one embodiment, KDF is a component of the purifying media. KDF preferably consists of finely divided metals such as, but not limited to, copper and zinc alloys. In certain instances, KDF can include calcium sulfate. In specific embodiments, the devices of the subject invention include purifying media comprising calcium sulfite, far infrared ceramics, and KDF metal particulate matter to dechlorinate the water and to reduce certain toxic metal compounds such as arsenic from the liquid. In a preferred embodiment, the KDF metal particulate matter is KDF 70.

Further, KDF is toxic to pathogens such as Ps. Fluorescens via a rapid reduction in redox potential as water-borne bacteria come into contact with KDF. An electrolytic field, in which most microorganisms cannot survive, is established by the exchange of electrons as a result of redox. Moreover, the process of forming hydroxyl radicals and peroxides from some of the water molecules interferes with microorganism ability to function. Accordingly, in one embodiment of the invention, the subject invention provides methods for removing microorganisms not only from the potable liquid being treated but also to prevent the colonization of microorganisms in the purifying material. In doing so, the subject invention ensures a biologically safe reusable device for treating potable liquids.

More preferably, the purifying material is composed of a combination of, by weight, about 85% calcium sulfite; about 10% metal particulate matter; and 5% far infrared ceramic. In addition, for the treatment of hot potable liquids (i.e., coffees and teas) the purifying material is composed of a combination of, by weight, about 50% calcium sulfite and activated granular carbon mix (percentages of calcium sulfite and activated granular carbon can range from, by weight, 0% to 100%), about 40% metal particulate matter, and about 10% far infrared ceramics.

The media retaining means of the invention includes any known, non-leaching materials that can confine the purifying media to a specific area or location while enabling contact between purifying media surface(s) and a potable liquid to be treated. In one embodiment, the media retaining means is a water-permeable container composed of materials with sufficient resiliency to confine the purifying media within the container, even after immersion into a liquid. Preferably, the water-permeable container is composed of a porous material, deformable, mesh-like substance (i.e., gauze, net, stainless steel mesh, etc.), or a stiff substance (i.e., plastics) having at least two apertures that are smaller in diameter to the purifying media, so as to prevent the escape of purifying media into the potable liquid to be treated.

In a preferred embodiment, the media retaining means is a woven wire mesh having a plurality of openings that are smaller in diameter than the smallest particle of purifying media. More preferably, the retaining means is a commercially available 140 mesh (105 micron), polyester plastic, nylon or stainless steel screen material.

In another embodiment, the media retaining means is an adhesive. In a related embodiment, the media retaining means is a non-toxic, edible glue that is used to securely attach the purifying media to a surface, i.e. of the manipulating means. In a preferred embodiment, the media retaining means is a commercially available hot melt, non-toxic polymeric plastic.

According to the subject invention, the media retaining means is attached to the manipulating means. The manipulating means is a structure that is easily grasped and maneuvered by the user to encourage the flow of a potable liquid through the purifying media in the media retaining means. The manipulating means can be of any structure known to the skilled artisan that can control the movement of a retaining means attached thereto.

In certain related embodiments, where the media retaining means is a water-permeable container, the media retaining means is detachably attached to the manipulating means. With such embodiments, the used media retaining means can be replaced with a new media retaining means for continuous use of the device. Alternatively, the media retaining means can be permanently attached to the manipulating means (i. e., non-toxic adhesive) and the device is disposed after use.

A manipulating means of the invention can be composed of flexible, stiff, or semi-flexible materials. For example, the manipulating means of the invention can be manufactured from, but is not limited to, either entirely or a mixture of cotton, glass, wood, metals, or synthetic materials (i. e., plastics, fiberglass). Further, the manipulating means can be of any form known to the skilled artisan to effect movement of the media retaining means when immersed in a potable liquid. For example, the manipulating means can be in the form of, without limitation, sticks, handles, strings, etc.

The device of the invention, comprising (1) a media retaining means; (2) a manipulating means; and (3) purifying media, can be manufactured for one-time use (i.e., disposable after treatment of a single potable liquid) or for re-use. For example, the subject device can be manufactured so that the media retaining means is detachably secured to the manipulating means. With this example, once the effectiveness of the purifying means in the media retaining means has expired, the expired purifying media and media retaining means is detached and a new, retaining means (and purifying material) can be attached to the manipulating means for effective treatment of potable liquids.

In a method of the invention, the potable liquid to be treated using a device of the invention is provided in a container and (1) a media retaining means of the subject invention is immersed into the potable liquid in the container; (2) the manipulating means is handled in order cause the media retaining means to move within the potable liquid so that the potable liquid comes into contact with the purifying media within the media retaining means; (3) then, the manipulating means, and corresponding media retaining means, are removed from the now treated potable liquid to allow for consumption of the potable liquid.

In a preferred embodiment, the manipulating means is handled for at least 30 seconds. More preferably, the manipulating means is handled for at least 15 seconds. Even more preferably, the manipulating means is handled for at least 5 seconds.

Following are examples that illustrate procedures for practicing the invention. These examples should not be construed as limiting. All percentages are by weight and all solvent mixture proportions are by volume unless otherwise noted.

### EXAMPLE 1

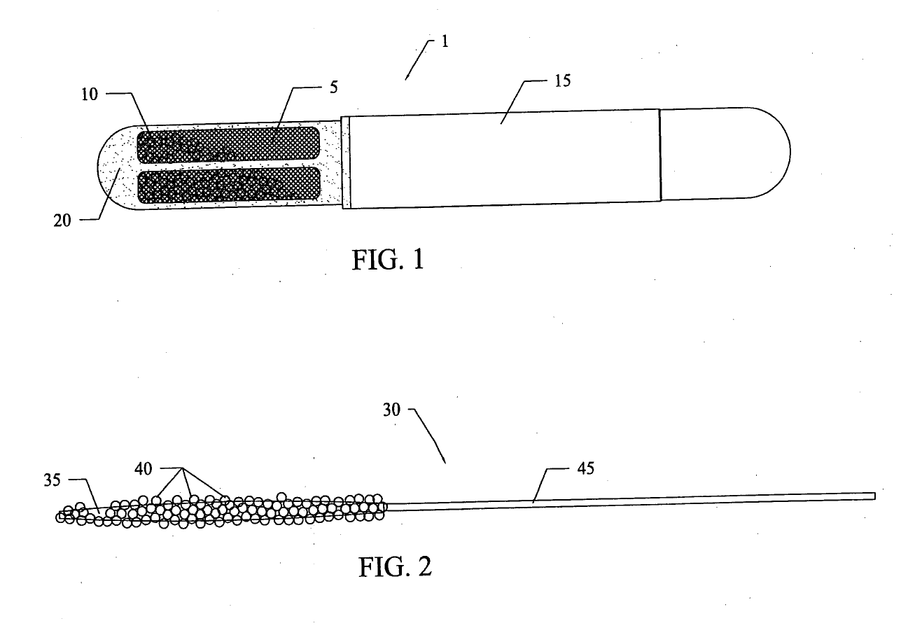

As illustrated in FIG. 1, one embodiment of the invention comprises a portable device 1 for treating potable liquids in accordance with the subject invention. The device 1 has a media retaining means 5 that is composed of a water-permeable material. Preferably, the water-permeable material is a container manufactured from a woven, metal-based mesh.

The media retaining means 5 contains purifying media 10. The purifying media 10 is composed of 85% calcium sulfite, 10% metal particulate matter, and 5% far infrared ceramics. The media retaining means 5 is attached to a manipulating means 15. For additional control over the media retaining means 5, the manipulating means 15 includes a cage 20, which surrounds the media retaining means 5.

### EXAMPLE 2

As illustrated in FIG. 2, another embodiment of the invention comprises a portable device 30 for treating potable liquids in accordance with the subject invention. The device 30 has a media retaining means 35 that is composed of a non-toxic adhesive that is insoluble in water. The media retaining means 35 retains the purifying media 40. The purifying media 40 is composed of 85% calcium sulfite and 15% far infrared ceramics. The media retaining means 35 is attached to a manipulating means 45. The manipulating means 45 is preferably a wooden stick.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A portable purifying device comprising a media retaining means; a manipulating means; and a purifying means, wherein the media retaining means retains the purifying media and is attached to the manipulating means.

2. The portable purifying device of claim 1, wherein the media retaining means is permanently attached to the manipulating means to provide a disposable device.

3. The portable purifying device of claim 1, wherein the media retaining means is detachably attached to the manipulating means to provide a reusable device.

4. The portable purifying device of claim 1, wherein the media retaining means is a mesh having a plurality of openings that are smaller in diameter than the smallest purifying media.

5. The portable purifying device of claim 4, wherein the media is a 140 mesh, nylon or stainless steel screen material.

6. The portable purifying device of claim 1, wherein the media retaining means is an adhesive.

7. The portable purifying device of claim 6, wherein the adhesive is a hot melt, non-toxic polymeric plastic.

8. The portable purifying device of claim 1, wherein the manipulating means is manufactured from non-toxic materials selected from the group consisting of: cotton, glass, wood, metals, plastics, or fiberglass.

9. The portable purifying device of claim 8, wherein the manipulating means is in the form of a stick, handle, or string.

10. The portable purifying device of claim 1, wherein the purifying media is selected from the group consisting of: far infrared emitting ceramics, calcium sulfite, activated granular carbon, metal particulate matter, resins, and finely broken pieces of natural materials.

11. The portable purifying device of claim 10, wherein the purifying media consists of calcium sulfite and far infrared emitting ceramics.

12. The portable purifying device of claim 11, wherein the media consists of 85% calcium sulfite and 15% far infrared emitting ceramics.

13. The portable purifying device of claim 11, wherein the purifying media further consists of metal particulate matter.

14. The portable purifying device of claim 13, wherein the metal particulate matter removes microorganisms from a potable liquid and prevents microorganism colonization in the purifying media.

15. The portable purifying device of claim 14, wherein the metal particulate matter is KDF and wherein the media consists of 85% calcium sulfite, 10% KDF, and 5% far infrared emitting ceramics.

16. The portable purifying device of claim 14, wherein the purifying media further consists of activated granular carbon.

17. A method for purifying potable liquid comprising:
a) inserting a portable purifying device into a container of potable liquid, wherein said device comprises a media retaining means; a manipulating means; and a purifying means, wherein the media retaining means retains the purifying media and is attached to the manipulating means;
b) handling the manipulating means to cause the media retaining means to move within the potable liquid so that the potable liquid comes into contact with the purifying media within the media retaining means; and
c) removing the device from the container.

18. The method of claim 17, wherein the manipulating means is handled for at least 30 seconds.

19. The method of claim 17, wherein the manipulating means is handled for at least 15 seconds.

20. The method of claim 17, wherein the manipulating means is handled for at least 5 seconds.

21. The method of claim 17, further comprising the steps of removing the media retaining means from the manipulating means after removing the device from the container; and introducing an unused media retaining means to the manipulating means for reuse of the device.
